(19) United States
(12) Patent Application Publication
(10) Pub. No.: US 2022/0147671 A1
(43) Pub. Date: May 12, 2022

(54) INFORMATION PROCESSING DEVICE

(71) Applicant: KABUSHIKI KAISHA TOSHIBA, Tokyo (JP)

(72) Inventor: Tomoyuki SUZUKI, Shinagawa (JP)

(73) Assignee: KABUSHIKI KAISHA TOSHIBA, Tokyo (JP)

(21) Appl. No.: 17/446,639

(22) Filed: Sep. 1, 2021

(30) Foreign Application Priority Data
Nov. 6, 2020 (JP) 2020-185856

(51) Int. Cl. G06F 30/27

(52) U.S. Cl. CPC G06F 30/27; G06F 2111/10

(57) ABSTRACT

According to an embodiment, an information processing device includes a memory storing therein library information and one or more processors coupled to the memory. The one or more processors are configured to: correct generation probabilities and a hyperparameter of machine learning on the basis of loss functions of linear regression equations; and extract nonlinear basis functions on the basis of the corrected generation probabilities from sub-libraries including the nonlinear basis functions, generate a plurality of linear regression equations obtained by combining the nonlinear basis functions of the plurality of types of sub-libraries, estimate coefficients of the linear regression equations by machine learning using the corrected hyperparameter, and calculate loss functions of the linear regression equations.

### CROSS-REFERENCE TO RELATED APPLICATIONS

This application is based upon and claims the benefit of priority from Japanese Patent Application No. 2020-185856, filed on Nov. 6, 2020; the entire contents of which are incorporated herein by reference.

### FIELD

Embodiments described herein relate generally to an information processing device.

### BACKGROUND

As a technique for modeling a physical phenomenon, there is a technique for acquiring a mathematical model that describes the physical phenomenon from time-series data by applying a symbolic regression problem, which is a kind of machine learning.

For example, when considering generating a thermal network model as a physical phenomenon model by using the conventional technique, because heat transfer phenomena are diverse, there is a possibility that a model of an appropriate physical phenomenon cannot be generated, for reasons that, for example, a search space is increased and the learning is not stable.

Therefore, an object of an embodiment is to generate a model of an appropriate physical phenomenon.

### BRIEF DESCRIPTION OF THE DRAWINGS

FIG. 1 is a schematic diagram illustrating an example of an information processing system;

FIG. 2 is a block diagram illustrating an example of a functional configuration of an information processing device;

FIG. 3A is a diagram illustrating sub-library definition information;

FIG. 3B is a diagram illustrating generation probability information;

FIG. 4 is a diagram illustrating an example of sensor information;

FIG. 5A is a diagram illustrating a state of internal processing;

FIG. 5B is a diagram illustrating an output example of information on a linear regression equation;

FIG. 6 is a flowchart illustrating an example of flow of information processing performed by the information processing device;

FIG. 7A is a diagram illustrating an example of temperature prediction by a machine learning model without considering a physical model;

FIG. 7B is a diagram illustrating an example of temperature prediction by a machine learning model considering the physical model; and

FIG. 7C is a diagram illustrating an example of temperature prediction based on the linear regression equation generated by the present embodiment.

### DETAILED DESCRIPTION

According to an embodiment, an information processing device includes: a memory configured to store therein a plurality of types of sub-libraries including respective nonlinear basis functions based on a dependent variable or an independent variable, and generation probabilities of the nonlinear basis functions included in the sub-libraries; and one or more processors coupled to the memory. The one or more processors are configured to: acquire a detection result of a sensor; perform calculation by using the detection result and the nonlinear basis functions of the sub-libraries, extract nonlinear basis functions from the sub-libraries including the nonlinear basis functions on a basis of the generation probabilities, generate a plurality of linear regression equations, in which the nonlinear basis functions of the plurality of types of sub-libraries are combined, for calculating the dependent variable, estimate coefficients of the linear regression equations by machine learning, and calculate loss functions of the linear regression equations by using a result of the calculation; correct the generation probabilities and a hyperparameter of the machine learning on a basis of the loss functions of the linear regression equations when a predetermined condition is not met; extract nonlinear basis functions on a basis of the corrected generation probabilities from the sub-libraries including the nonlinear basis functions, generate linear regression equations, in which the nonlinear basis functions of the plurality of types of sub-libraries are combined, estimate coefficients of the linear regression equations by machine learning using the corrected hyperparameter, and calculate loss functions of the linear regression equations; and output, to an output unit, a linear regression equation selected from the linear regression equations generated by the regression equation generation module or the regression equation regeneration module when the condition is met.

Hereinafter, an information processing device according to an embodiment will be described in detail with reference to the accompanying drawings. The present disclosure is not limited to the embodiment.

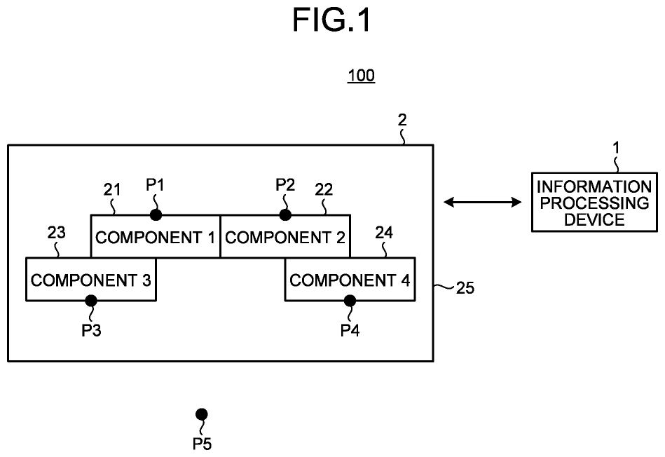

FIG. 1 is a schematic diagram illustrating an example of an information processing system 100.

The information processing system 100 includes an information processing device 1 and an electronic apparatus 2. The information processing device 1 and the electronic apparatus 2 are connected to be able to exchange data or signals.

The electronic apparatus 2 is equipment including one or a plurality of components and driven by supplied electric power. The electronic apparatus 2 is applied to, for example, various apparatuses in which one or a plurality of electronic components are mounted in one rack. Specifically, the electronic apparatus 2 is applied to various electronic apparatuses such as a digital broadcasting transmitter, a data relay apparatus, a computer, and a server.

The electronic apparatus 2 includes a housing 25 for housing various components and the like.

The housing 25 is a main body portion of the electronic apparatus 2, and is an exterior for housing various components and devices. In the present embodiment, a case where the housing 25 is a box-like member having a hollow inside will be described as an example.

A plurality of components and a plurality of sensors are arranged in the housing 25. In the present embodiment, an embodiment in which the components and the sensors are arranged in the housing 25 will be described as an example.

A component 21 and a component 22 are electronic components. The electronic component is, for example, a component that is driven according to the supplied electric power. The electronic components include heat-generating components that generate heat when driven according to the supplied electric power. Note that “drive” includes both an electric drive and a mechanical drive. The electric drive includes, for example, processing by a processor such as a central processing unit (CPU). The mechanical drive includes, for example, drive of a motor. Note that the component 21 and the component 22 are heat-generating components.

The component 21 and the component 22 serving as heat generating components are, for example, processors such as the CPU and a graphics processing unit (GPU). Note that the component 21 and the component 22 may be any desired component that generates heat by being driven according to the supplied electric power, and are not limited to the CPU and the GPU. For example, the component 21 and the component 22 may be a field effect transistor (FET), an intelligent power module (IPM), the motor, an electronic circuit, and the like.

A component 23 and a component 24 are metal blocks such as aluminum. The component 23 and the component 24 have a cooling function.

The sensors are arranged in the electronic apparatus 2. The sensors measure, for example, physical quantities of environmental changes at positions P1 to P5. For example, the sensors detect the physical quantities of temperature, current, voltage, and wind speed at the positions P1 to P5, and output detection results as detection values. The physical quantity and the detected value are represented by numerical values indicating, for example, temperature, current, voltage, wind speed, and the like. Note that pressure, rotation speed of an air cooling fan, and the like may be included.

The sensors described above are, for example, a temperature sensor, a flow rate sensor, a current sensor, a voltage sensor, and the like.

The sensors may be arranged at positions inside the housing 25 or outside the housing 25 where the environmental changes can be measured. The sensors may be built in as a product or may be externally attached only at the time of measurement.

The information processing device 1 is an apparatus that generates a model for predicting the temperature of the electronic apparatus on the basis of a state of the electronic apparatus 2. The information processing device 1 and each of the sensors provided in the electronic apparatus 2 are connected to be able to exchange data or signals. Note that the information processing device 1 may be further connected to an electronic apparatus including various information processing devices other than the sensor mounted on the electronic apparatus 2 so that data or signals can be exchanged. For example, the information processing device 1 may be connected to the sensors and at least one of the components so that data or signals can be exchanged. Furthermore, the information processing device 1 is, for example, a server, a workstation, or the like.

For example, the information processing device 1 may collectively transmit data acquired from the sensors to a remote information processing device by a storage medium or a cloud.

Next, an example of a functional configuration of the information processing device 1 will be described.

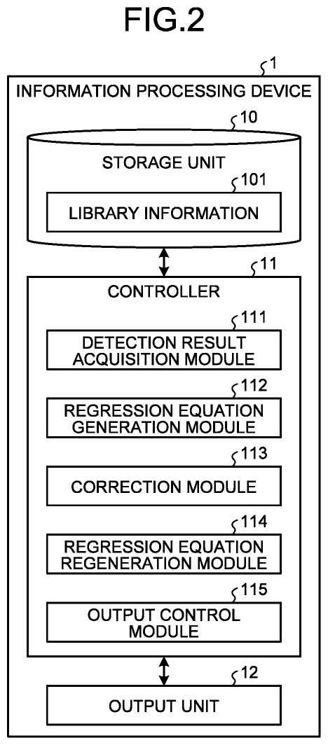

FIG. 2 is a block diagram illustrating the example of the functional configuration of the information processing device 1.

The information processing device 1 and the sensors are connected so that data or signals can be exchanged. Note that, as described above, the information processing device 1 may be connected to various kinds of electronic apparatus other than the sensors so that data or signals can be exchanged. The information processing device 1 of the present embodiment is an apparatus that generates a model based on a thermal network method. The information processing device 1 outputs a linear regression equation capable of outputting the temperature of the electronic apparatus 2, as the model.

The information processing device 1 includes a storage unit 10, a controller 11, and an output unit 12. The controller 11 is connected to the storage unit 10 and the output unit 12 so that data or signals can be exchanged.

The storage unit 10 stores therein various types of data. The storage unit 10 is, for example, a storage medium such as a known hard disk drive (HDD). In the present embodiment, the storage unit 10 stores therein library information 101 in advance.

The library information 101 is information including sub-library definition information that is information in which a plurality of types of sub-libraries including nonlinear basis functions are defined, and generation probability information that is information on generation probability of each of the nonlinear basis functions included in each sub-library.

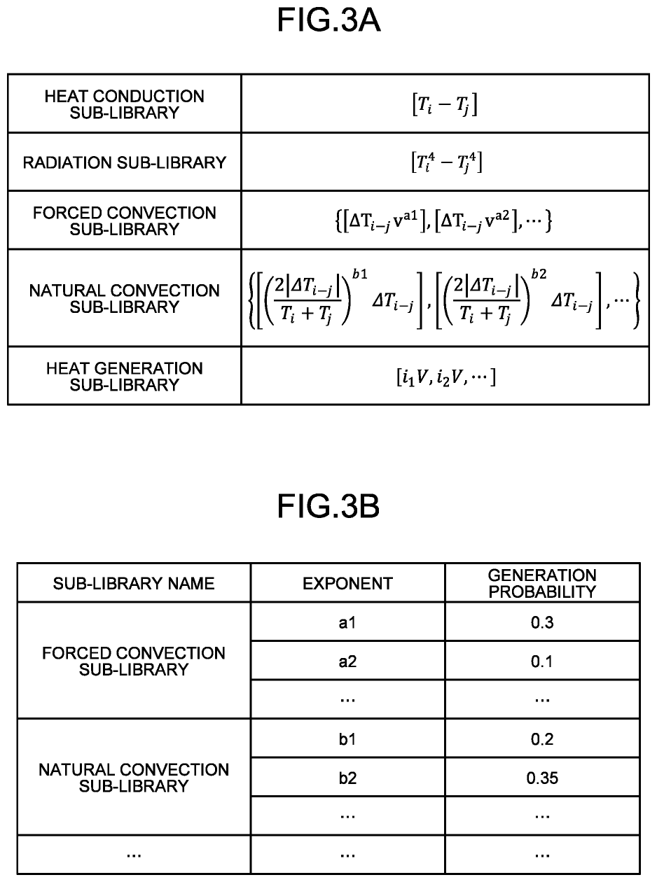

First, the sub-library will be described with reference to FIG. 3A. Each sub-library is a sub-library for generating linear regression equation that represents a thermal model. FIG. 3A is a diagram illustrating sub-library definition information. As illustrated in FIG. 3A, the sub-libraries include a heat conduction sub-library, a radiation sub-library, a forced convection sub-library, a natural convection sub-library, and a heat generation sub-library. Each sub-library includes one or a plurality of nonlinear basis functions. Note that the sub-library is not limited to one illustrated in FIG. 3A, and a phase-change sub-library that considers a phase change may be defined.

Ti and Tj illustrated in FIG. 3A are temperatures at any of the positions P1 to P5. Furthermore, ΔT and ΔTᵢ₋ⱼ are temperature differences between two points. V is a velocity (wind speed). V is a voltage. i₁ and i₂ are currents. Thus, the sub-libraries include nonlinear basis functions based on a dependent variable (temperature) and independent variables (velocity, current and voltage).

As illustrated in FIG. 3A, each sub-library contains one or more nonlinear basis functions. Furthermore, the forced convection sub-library and the natural convection sub-library include the nonlinear basis functions having different exponents.

In the above thermal model, an energy conservation law that holds for a node (temperature measurement point) is expressed by a node equation illustrated in the following equation (1).

$${\sum }_{\begin{matrix}j = 1 \\ j \neq i\end{matrix}}^{N} \frac{1}{{R}_{ij}^{( m )}} ( {T}_{i}^{( m )} - {T}_{j}^{( m )} ) = {Q}_{i}^{( m )} - \frac{{C}_{i}^{( m )}}{Δ t} ( {T}_{i}^{( m )} - {T}_{i}^{( m - 1 )} ) \qquad ( 1 )$$

In the above equation (1), R is thermal resistance, T is temperature, Q is calorific value, and Δt is time interval. Furthermore, m is a subscript of time.

When the above equation (1) is transformed, the following equation (2) is obtained.

$$\frac{1}{Δ t} ( {T}_{i}^{( m )} - {T}_{i}^{( m - 1 )} ) = \frac{\partial T}{\partial t} = \frac{1}{{C}_{i}^{( m )}} \{ {Q}_{i}^{( m )} - {\sum }_{\begin{matrix}j = 1 \\ j \neq i\end{matrix}}^{N} \frac{1}{{R}_{ij}^{( m )}} ( {T}_{i}^{( m )} - {T}_{j}^{( m )} ) \} \qquad ( 2 )$$

As shown by the right side of the equation (2), if a nonlinear basis function indicating Q/C and ΔT/RC can be prepared, an appropriate linear regression equation can be derived. When dimensions and physical properties do not change, such as in maintenance operations, the nonlinear basis functions of the heat conduction sub-library, the radiation sub-library, the forced convection sub-library, and the natural convection sub-library are proportional to ΔT/RC. Furthermore, the heat generation sub-library is proportional to Q/C. The information processing device 1 of the present embodiment generates the linear regression equation according to the thermal model by using the sub-libraries defined in the sub-library definition information.

The library information 101 further includes the information on the generation probability, which is a probability of being selected from the nonlinear basis functions included in the same sub-library.

Subsequently, the generation probability will be described with reference to FIG. 3B. FIG. 3B is a diagram illustrating the generation probability information. As illustrated in FIG. 3B, the sub-library, the exponent, and the generation probability are associated with each other.

Returning to FIG. 2, the output unit 12 outputs various information. In the present embodiment, the output unit 12 outputs information on the model for predicting the temperature of the electronic apparatus. Details of the information on the model for predicting the temperature of the electronic apparatus will be described later.

The output unit 12 includes at least one of a display function for displaying various information and a communication function for communicating data with an external apparatus. The external apparatus is an apparatus provided outside the electronic apparatus 2. The electronic apparatus 2 and the external apparatus may be able to communicate with each other via a network or the like. For example, the output unit 12 is configured by combining at least one of a known display device and a known communication device.

Next, a controller 30 will be described.

The controller 30 includes a detection result acquisition module 111, a regression equation generation module 112, a correction module 113, a regression equation regeneration module 114, and an output control module 115.

The detection result acquisition module 111, the regression equation generation module 112, the correction module 113, the regression equation regeneration module 114, and the output control module 115 are implemented by, for example, one or a plurality of processors. For example, each of the above components may be implemented by causing the processor such as the CPU to execute a computer program, that is, by software. Each of the above components may be implemented by the processor such as a dedicated IC, that is, by hardware. Each of the above components may be implemented by using software and hardware in combination. When the processors are used, each processor may implement one of the components, or may implement two or more of the components.

The detection result acquisition module 111 acquires the detection results detected by the sensors. For example, the detection result acquisition module 111 acquires the detection results of measuring at predetermined time intervals the temperatures at the positions P1 to P5, the wind speed at the position P5, the currents at the positions P1 and P2, and the voltage at the position P1 illustrated in FIG. 1. Note that the detection result acquisition module 111 may acquire information on the rotation speed and voltage of the air cooling fan, and calculate the wind speed on the basis of the information.

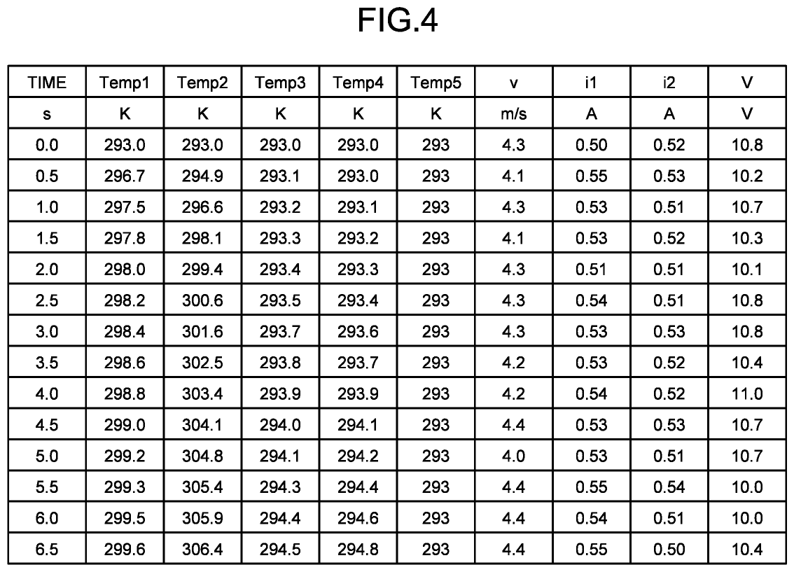

Here, an example of data acquired by the detection result acquisition module 111 is illustrated in FIG. 4. FIG. 4 is a diagram illustrating an example of sensor information. As illustrated in FIG. 4, for example, the data measured every 0.5 seconds is acquired. Temp1 to Temp5 illustrated in FIG. 4 are the temperatures at the positions P1 to P5. V illustrated in FIG. 4 is the wind speed at the position P5. i₁ and i₂ are the currents at the positions P1 and P2. V illustrated in FIG. 4 is the voltage at the position P1. Note that the detection result acquisition module 111 may register the acquired detection result in the storage unit 10.

Returning to FIG. 2, the regression equation generation module 112 generates a plurality of regression equations. Specifically, the regression equation generation module 112 first differentiates each of Temp1 to Temp5 acquired at the corresponding time, by time. Furthermore, the regression equation generation module 112 generates matrix data in which each piece of data acquired by the detection result acquisition module 111 is input to the nonlinear basis function in each sub-library. In this way, the regression equation generation module 112 calculates using the detection result of the sensor and the nonlinear basis functions.

Subsequently, the regression equation generation module 112 extracts nonlinear basis functions from the sub-libraries including the nonlinear basis functions on the basis of the generation probabilities, and generates the linear regression equations for calculating each of Temp1 to Temp5 by combining the nonlinear basis functions of the plurality of types of sub-libraries.

When extracting a nonlinear basis function from the sub-library including the nonlinear basis functions on the basis of the generation probability, the regression equation generation module 112 preferentially extracts the exponent having a high generation probability of the generation probability information.

Subsequently, the regression equation generation module 112 determines coefficients of the linear regression equations by sparse estimation of a known technique. For example, the regression equation generation module 112 determines the coefficients by the least squares method, and then sets the coefficient equal to or less than a predetermined threshold value (hyperparameter) to 0. Furthermore, the regression equation generation module 112 updates the coefficient by performing the least squares method again with a candidate function (nonlinear basis function) having the remaining non-zero coefficient, and sets the coefficient equal to or less than the predetermined threshold value to 0. Note that the regression equation generation module 112 repeats a plurality of times a process of updating the coefficient by performing the least squares method again with the candidate function and of setting the coefficient equal to or less than the threshold value to 0.

Note that the regression equation generation module 112 may determine a coefficient by other known machine learning in addition to determining the coefficients by sparse estimation.

Furthermore, the regression equation generation module 112 calculates loss functions using the linear regression equations and a result of the above calculation. A method for calculating the loss functions is implement by a known method. For example, the regression equation generation module 112 generates the loss functions based on an error between a result of inputting the matrix data, which is obtained by inputting each piece of data acquired by the detection result acquisition module 111 to the nonlinear basis function in each sub-library, to the generated linear regression equations, and a result of differentiating each of Temp1 to Temp5 at the corresponding time, by time. Note that the regression equation generation module 112 may calculate the loss functions based on not only the above-described error but also a degree of simplicity of the equation.

If conditions described later are not met, the correction module 113 corrects the hyperparameter and the generation probabilities used when determining the coefficients of the linear regression equations on the basis of the loss functions of the linear regression equations. The method for correcting the hyperparameter may be a method of the related art (for example, a method described in S. L. Brunton, J. L. Proctor, J. N. Kutz, “Discovering governing equations from data by sparse identification of nonlinear dynamical systems”, Proc. Natl. Acad. Sci., 113 (2016), pp. 3932-3937). The correction module 113 adds a value to the hyperparameter when the loss function of each linear regression equation falls below a predetermined threshold value. In contrast, the correction module 113 subtracts a value from the hyperparameter when the loss function of each linear regression equation is equal to or more than the threshold value.

The correction module 113 increases the generation probability of the sub-library that constitutes the linear regression equation of the smallest loss function among the loss functions of the linear regression equations generated by the same hyperparameter, and reduces the generation probability of other sub-libraries. Note that as a method for correcting the generation probability, for example, the generation probability of the sub-library having a high generation probability may be further increased. That is, the generation probability may be corrected so as to narrow down the nonlinear basis function to be extracted.

The regression equation regeneration module 114 extracts nonlinear basis functions from the sub-libraries including the nonlinear basis functions on the basis of the generation probabilities after correction by the correction module 113, generates linear regression equations obtained by combining the nonlinear functions of the plurality of types of sub-libraries, estimates coefficients of the linear regression equations by sparse estimation using the hyperparameter corrected by the correction module 113, and calculates loss functions of the linear regression equations.

If the regression equation regeneration module 114 has not generated the linear regression equation for a predetermined number of times, the correction module 113 corrects the hyperparameter and the generation probabilities again. Then, the regression equation regeneration module 114 calculates the loss functions of the linear regression equations on the basis of the hyperparameter and the generation probabilities that have been corrected again. In this way, the controller 11 corrects the hyperparameter and the generation probabilities for the predetermined number of times, and calculates the loss functions using the hyperparameter and the generation probabilities that have been corrected.

The output control module 115 outputs a linear regression equation selected from the linear regression equations to the output unit 12 if a predetermined condition is met. Examples of this condition include the number of times the regression equation regeneration module 114 has generated the linear regression equations. Furthermore, the above condition may be that the loss functions of the linear regression equations calculated by the regression equation generation module 112 or the loss functions of the linear regression equations calculated by the regression equation regeneration module 114 is equal to or less than the threshold value.

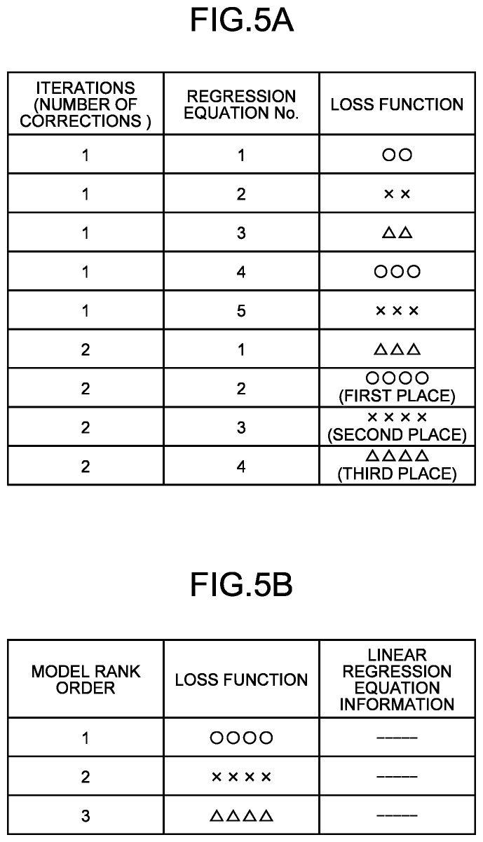

Furthermore, the output control module 115 outputs information on the linear regression equations selected by a rank order based on the loss functions of the linear regression equations to the output unit. Here, an example in which the output control module 115 outputs the linear regression equations will be described with reference to FIGS. 5A and 5B.

FIG. 5A is a diagram illustrating a state of internal processing. Specifically, FIG. 5A is a diagram in which the number of iterations (number of corrections) for the linear regression equations generated by the regression equation regeneration module 114, a regression equation No. indicating an identification number of the linear regression equation, and the loss function are associated with each other.

As illustrated in FIG. 5A, the loss function “∘∘∘∘” of the linear regression equation in which “the number of iterations” is “2” and the “regression equation No.” is “2” is the first place (a value indicated by the loss function is the smallest), the loss function “xxxx” of the linear regression equation in which “the number of iterations” is “2” and the “regression equation No.” is “3” is the second place, and the loss function “ΔΔΔΔ” of the linear regression equation in which “the number of iterations” is “2” and the “regression equation No.” is “4” is the third place.

FIG. 5B is a diagram illustrating an output example of the information on the linear regression equation. The output control module 115 outputs the loss function and linear regression equation information to the output unit 12 on the basis of the rank order of the loss function illustrated in FIG. 5A. Here, the linear regression equation information is information indicating the linear regression equation, such as information indicating a simultaneous equation of nodes and a linear combination of the basis functions. Note that the output control module 115 may output the linear regression equation information on a separate screen.

Note that the output control module 115 may select the linear regression equation having the smallest loss function among the linear regression equations.

Note that the output control module 115 may transmit and output the selected linear regression equation to another information processing device. Thus, the other information processing device can perform temperature prediction calculation using the linear regression equation.

Next, a flow of information processing performed by the information processing device 1 will be described.

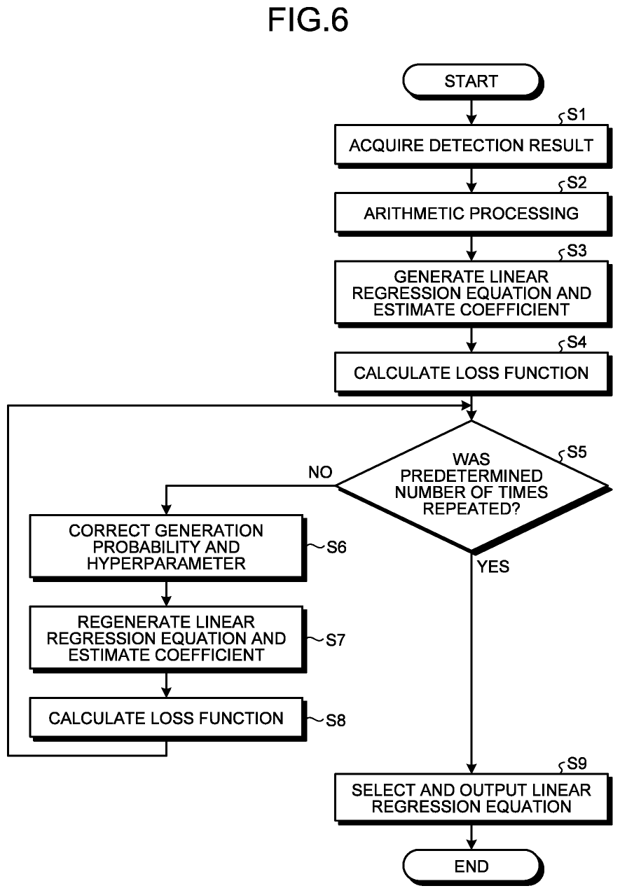

FIG. 6 is a flowchart illustrating an example of the flow of the information processing performed by the information processing device 1.

The detection result acquisition module 111 acquires the detection results of the sensors (Step S1). Subsequently, the regression equation generation module 112 uses the detection results of the sensors to differentiate each of Temp1 to Temp5 acquired at the corresponding time, by time, and to generate the matrix data in which each piece of data acquired by the detection result acquisition module 111 is input to the nonlinear basis function in each sub-library. In this way, the regression equation generation module 112 performs arithmetic processing of the nonlinear basis function using the detection results of the sensors (Step S2).

The regression equation generation module 112 extracts the nonlinear basis function from the sub-library including the nonlinear basis functions on the basis of the generation probability, and generates the linear regression equations for calculating each of Temp1 to Temp5 by combining the nonlinear basis functions of the plurality of types of sub-libraries. Furthermore, the regression equation generation module 112 determines the coefficients of the linear regression equations by sparse estimation (Step S3).

The regression equation generation module 112 calculates the loss function using the linear regression equations and the result of the above calculation (Step S4). If the linear regression equation has not been generated for the predetermined number of times (No at Step S5), the correction module 113 corrects the generation probability and the hyperparameter on the basis of the loss function of the linear regression equation (Step S6). For example, the correction module 113 adds a value to the hyperparameter when the loss function of each linear regression equation falls below the predetermined threshold value. The correction module 113 increases the generation probability of the sub-library that constitutes the linear regression equation of the smallest loss function among the loss functions of the linear regression equations generated by the same hyperparameter, and reduces the generation probability of the other sub-libraries.

The regression equation regeneration module 114 extracts the nonlinear basis function from the sub-library including the nonlinear basis functions on the basis of the generation probability after correction by the correction module 113, generates the linear regression equations combining the nonlinear functions of the plurality of types of sub-libraries, and estimates the coefficients of the linear regression equations by sparse estimation using the hyperparameter corrected by the correction module 113 (Step S7). Furthermore, the regression equation regeneration module 114 calculates the loss functions of the linear regression equations (Step S8), and proceeds to Step S5.

In Step S5, when the regression equation regeneration module 114 generates the linear regression equation for the predetermined number of times, the output control module 115 outputs the linear regression equation selected from the linear regression equations to the output unit 12 (Step S9). Then, this routine is terminated.

As described above, the information processing device 1 of the present embodiment includes the storage unit 10 for storing the library information, the detection result acquisition module 111, the regression equation generation module 112, the correction module 113, and the regression equation regeneration module 114, and the output control module 115.

The storage unit 10 stores therein the library information 101 including the sub-library definition information that is the information on the plurality of types of sub-libraries including nonlinear basis functions based on the dependent variable or the independent variable, and the generation probability information that is the information on the generation probability of each of the nonlinear basis functions included in each sub-library.

The detection result acquisition module 111 acquires the detection results of the sensors. The regression equation generation module 112 calculates the non-linear base function of the sub-library using the detection results, extracts the nonlinear basis function from the sub-library including the nonlinear basis functions on the basis of the generation probability, generates the linear regression equations combining the nonlinear basis functions of the plurality of types of sub-libraries, estimates the coefficients of the linear regression equations by machine learning, and calculates the loss functions of the linear regression equations using the calculated result.

The correction module 113 corrects the generation probability and the hyperparameter of machine learning on the basis of the loss function of the linear regression equation. The regression equation regeneration module 114 extracts the nonlinear basis function from the sub-library including the nonlinear basis functions on the basis of the corrected generation probability, generates the linear regression equations combining the nonlinear basis functions of the plurality of types of sub-libraries, estimates the coefficients of the linear regression equations by machine learning using the corrected hyperparameter, and calculates the loss functions of the linear regression equations.

The output control module 115 outputs the linear regression equation selected from the linear regression equations to the output unit 12 if the predetermined condition is met.

In this way, the information processing device 1 extracts the nonlinear basis function from the sub-library including the nonlinear basis functions on the basis of the generation probability, generates the linear regression equations combining the nonlinear basis functions of the plurality of types of sub-libraries, and regenerates the linear regression equation while tuning the generation probability and the hyperparameter of machine learning until the predetermined condition is met.

In this case, the information processing device 1 regenerates the linear regression equation while tuning the generation probability and the hyperparameter of machine learning, and narrows down the linear regression equation to be generated by changing the generation probability. As a result, the information processing device 1 can output an appropriate linear regression equation while reducing a search space. That is, the information processing device 1 can generate a model of an appropriate physical phenomenon.

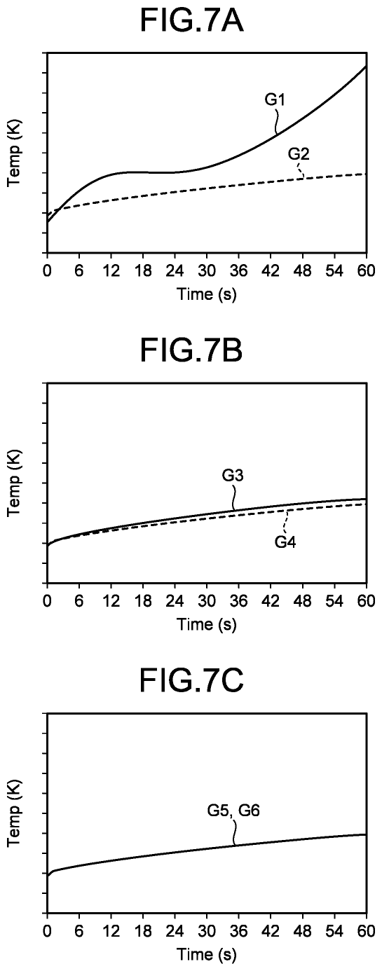

Here, an example of predicting the temperature on the basis of the information acquired from the sensor will be described with reference to graphs of FIGS. 7A to 7C. FIG. 7A is a diagram illustrating an example of temperature prediction by machine learning without considering a physical model. FIG. 7A includes a graph G1 and a graph G2. The graph G1 is a prediction graph of a temperature Temp1 predicted by a result of deep learning with the measurement data by the sensor. The graph G2 is a graph of correct answer data of the temperature Temp1. The vertical axis is temperature and the horizontal axis is time. As illustrated in FIG. 7A, there is a difference between the prediction graph and the graph of the correct answer data.

FIG. 7B is a diagram illustrating an example of temperature prediction by a machine learning model considering a known physical model. FIG. 7B includes a graph G3 and a graph G4. The graph G3, although not including a sub-library as in the present embodiment, is a graph predicting the temperature Temp1 on the basis of the physical model. The graph G4 is the graph of the correct answer data of the temperature Temp1. As illustrated in FIG. 7B, there is a difference between the prediction graph and the graph of the correct answer data, although not as much as in FIG. 7A. Furthermore, as illustrated in FIG. 7B, the difference increases with the passage of time, indicating that it is not suitable for long-term prediction.

FIG. 7C is a diagram illustrating an example of temperature prediction based on the linear regression equation generated by the present embodiment. FIG. 7C includes a graph G5 and a graph G6. The graph G5 is a graph predicting the temperature Temp1 on the basis of the sub-library as in the present embodiment. The graph G6 is the graph of the correct answer data of the temperature Temp1. As illustrated in FIG. 7C, the prediction graph and the graph of the correct answer data are almost the same. As described above, the information processing device 1 of the present embodiment can output the linear regression equation that can be predicted more appropriately by generating the linear regression equation using the sub-library.

The information processing device 1 estimates the coefficients of the linear regression equations by sparse estimation. The linear regression equation includes many basis functions, most of which have zero coefficients, and thus the coefficients can be appropriately estimated by using sparse estimation.

The information processing device 1 generates the linear regression equation that is an equation for calculating the temperature using the temperature as the dependent variable. In order to calculate the temperature, since there are wide variety of heat transfer phenomena, the search space tends to be increased, however, the library information 101 as described above is stored, and the linear regression equation is generated/regenerated using the library information 101, so that an appropriate model of a thermal phenomenon can be generated.

The information processing device 1 stores therein the plurality of types of sub-libraries including the nonlinear basis functions of independent variables corresponding to velocity, current and voltage. In this way, the information processing device 1 stores therein the nonlinear basis functions related to velocity, current and voltage that are highly related to temperature, and generates the linear regression equation using the nonlinear basis functions, so that the appropriate model of the thermal phenomenon can be generated.

Since the information processing device 1 stores therein, as the plurality of types of sub-libraries, the nonlinear basis functions of the heat conduction sub-library, the radiation sub-library, the forced convection sub-library, the natural convection sub-library, and the heat generation sub-library, the information processing device 1 stores therein the sub-library corresponding to the node equation, so that the appropriate model of the thermal phenomenon can be generated.

The output control module 115 of the information processing device 1 outputs the information on the selected linear regression equations to the output unit 12 according to the rank order based on the loss function of each of the linear regression equations. In this way, the information processing device 1 can output the information on the linear regression equations selected according to the rank order based on the loss function, thereby outputting pieces of information that can be compared and examined by a user of the information processing device 1.

In the above-described embodiment, while a case where the information processing device 1 generates the linear regression equation of the thermal model has been described, the linear regression equation of a model of another physical phenomenon (for example, electric resistance or physical deformation amount) may be generated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a memory configured to store therein a plurality of types of sub-libraries including respective nonlinear basis functions based on a dependent variable or an independent variable, and generation probabilities of the nonlinear basis functions included in the sub-libraries; and
one or more processors coupled to the memory and configured to:
acquire a detection result of a sensor;
perform calculation by using the detection result and the nonlinear basis functions of the sub-libraries, extract nonlinear basis functions from the sub-libraries including the nonlinear basis functions on a basis of the generation probabilities, generate a plurality of linear regression equations, in which the nonlinear basis functions of the plurality of types of sub-libraries are combined, for calculating the dependent variable, estimate coefficients of the linear regression equations by machine learning, and calculate loss functions of the linear regression equations by using a result of the calculation;
correct the generation probabilities and a hyperparameter of the machine learning on a basis of the loss functions of the linear regression equations when a predetermined condition is not met;
extract nonlinear basis functions on a basis of the corrected generation probabilities from the sub-libraries including the nonlinear basis functions, generate linear regression equations, in which the nonlinear basis functions of the plurality of types of sub-libraries are combined, estimate coefficients of the linear regression equations by machine learning using the corrected hyperparameter, and calculate loss functions of the linear regression equations; and
output, to an output unit, a linear regression equation selected from the linear regression equations generated by the regression equation generation module or the regression equation regeneration module when the condition is met.

2. The device according to claim 1, wherein the coefficients of the linear regression equations are estimated by sparse estimation.

3. The device according to claim 1, wherein the dependent variable includes a variable corresponding to temperature.

4. The device according to claim 3, wherein the independent variable includes variables corresponding to velocity, current, and voltage.

5. The device according to claim 3, wherein the plurality of types of sub-libraries include two or more of a heat conduction sub-library, a radiation sub-library, a forced convection sub-library, a natural convection sub-library, and a heat generation sub-library.

6. The device according to claim 1, wherein the one or more processors are configured to output, to the output unit, information on linear regression equations selected according to a rank order based on the loss functions of the linear regression equations.
